(19) United States
(12) Patent Application Publication
(10) Pub. No.: US 2003/0135836 A1
(43) Pub. Date: Jul. 17, 2003

(54) Gated clock tree synthesis

(76) Inventors: Jui-Ming Chang, San Jose, CA (US); Chin-Chi Teng, Sunnyvale, CA (US); Wei-Jin Dai, Cupertino, CA (US)

Correspondence Address: SMITH-HILL AND BEDELL, 12670 N W BARNES ROAD, SUITE 104, PORTLAND, OR, 97229

(21) Appl. No.: 10/323,432

(22) Filed: Dec. 18, 2002

Related U.S. Application Data
(60) Provisional application No. 60/342,006, filed on Dec. 18, 2001.

(51) Int. Cl. G06F 9/455; G06F 17/50

(52) U.S. Cl. 716/11

(57) ABSTRACT

A gated clock tree including a hierarchy of gates is synthesized by separately synthesizing a subtree residing under each gate, starting with the subtrees residing under gates at lowest level of the hierarchy and working upwards though the gate hierarchy. To design a subtree under a selected gate at any given level of the gate hierarchy, a centroid of a set of all downstream sinks and gates residing at a next lower level of the hierarchy that are to receive the clock signal via the selected gate is initially determined. A set of subtree endpoints are then established, each residing between the centroid and a corresponding sink or gate of the set of downstream sinks and gates. A balanced subtree is then designed to convey the clock signal from the selected gate to each subtree endpoint, and a separate signal path is designed to convey the clock signal from each subtree endpoint to a corresponding downstream sink or gate of the set. Buffers are inserted into the signal paths, sized and positioned as necessary to substantially minimize differences in path delays between the selected gate and all sinks of the clock tree that are downstream of selected gate.

### CROSS-REFERENCE TO RELATED APPLICATIONS

The present application claims the benefit of the filing date of U.S. Provisional Application No. 60/342,006, filed Dec. 18, 2001.

### BACKGROUND OF THE INVENTION

1. Field of the Invention

The present invention relates in general to computer-aided design tools for generating integrated circuit (IC) layouts, and in particular to a method for synthesizing a gated clock tree for an IC.

2. Description of Related Art

Clock Tree Synthesis

Integrated circuits (ICs) often include clocked devices (“sinks”) such as registers, latches and flip-flops that carry out logic or data storage operations only in response to edges of clock signals applied as inputs to the sink. For example a register produces output signals of states controlled by states of stored data, but stores its input data only in response to an edge of a clock signal. Thus state changes in the register's output signals are synchronized to edges of the clock signal. An IC may include large numbers of registers or other kinds of sinks, for example, to synchronize timing of state changes in signals passing between various sections of the IC.

A clock tree is a tree-like network formed by conductors and buffers for distributing a clock signal to all of the sinks that are clocked by that particular clock signal. In order to make sure that state changes in all of the output signals of sinks that are to be clocked by the same clock signal occur synchronously, the clock tree must be balanced to ensure that each clock signal edge arrives at all of the sinks at substantially the same time, with limited variation in arrival time (“skew”) for sink-to-sink.

FIG. 1 is a simplified plan view of an IC showing positions of a set of sinks 10 that are to receive a clock signal supplied to the IC at a pin 14. Although FIG. 1 shows the IC has only a few syncs 10 to be driven by one clock signal, a typical IC may have thousands of sinks clocked by clock signals delivered by more than one clock tree.

After using a layout tool to establish a suitable position for each cell of the IC, including its syncs 10, an IC designer employs a clock tree synthesis (CTS) tool to automatically design a clock tree for delivering the clock signal from pin 14 to all sinks 10. A typical CTS tool employs a conventional “zero skew” algorithm which initially assigns sinks 10 to a set of “clusters” 18 as illustrated in FIG. 2 such that the number of sinks 10 assigned to each cluster 18 is no greater than the fan out of a single buffer. The layout tool then adds a separate “first level” buffer 20 to the IC layout for each cluster 18, and also lays out signal paths between the output of each first level buffer 20 and clock input of the sinks 10 of the corresponding cluster, thereby providing a first level of the clock tree. FIG. 3 schematically illustrates a clock tree 25 including sinks 10, first level buffers 20, and the signal paths there between.

The zero-skew algorithm then assigns groups of nearby buffers 20 to a set of clusters 19 as illustrated in FIG. 4, and the layout tool adds a set of second level buffers 21 to the layout for driving each cluster 19 of buffers 20, along with signal paths therebetween, as depicted schematically in FIG. 3. The CTS tool repeats the process iteratively, organizing each new buffer level into a set of clusters and then providing a next higher level of buffers to drive the buffers of each cluster. In the example of FIG. 3 a single third level buffer 22 is provided to drive second level buffers 21. The number of buffer levels needed to fan the clock signal out to all sinks depends on the number of sinks and the number of buffers or sinks each buffer can drive. Since in the example of FIGS. 1-3 there are only a relatively small number of sinks 10, clock tree 25 requires only three levels of buffers 20-22, but a clock tree for a large IC may include many more buffer levels to fan the clock signal out to all of the sinks requiring it.

Since path lengths between buffers vary, clock tree 25 of FIG. 3 will not likely be sufficiently balanced even when all buffers 20, 21 and 22 have the same delay because a clock signal edge departing the node 14 at the root of the clock tree will have to travel farther to reach some sinks 10 than others and impedance characteristics of the signal paths may vary. To compensate for such differences in clock signal path lengths and impedances, the CTS tool balances clock tree 25 by inserting additional buffers 23 in various branches of the clock tree as illustrated in FIG. 5. The effect that each inserted buffer 23 has on the delay through the clock tree branch in which it resides depends largely on the size of the buffer and on its position within the branch. By carefully sizing and positioning each buffer 23, the CTS tool can usually balance the clock tree to ensure that a clock signal edge entering the clock tree at node 14 will arrive at all sinks 10 at substantially the same time with a skew that is within a specified limit.

The ability of a conventional zero skew algorithm to synthesize a well-balanced clock tree stems largely from the way it organizes the most closely positioned sinks 10 and buffers 20-22 into clusters at each iterative step of the clock tree synthesis process. Such iterative “clusterization” tends to produce a relatively well balanced clock tree at the “pre-insertion” stage of the clock tree illustrated in FIG. 3 where the CTS tool has not yet begun to insert the additional buffers 23. Thus the CTS tool generally need only insert the additional buffers 23 into clock tree 25 as illustrated in FIG. 5 to make relatively small changes to path delays as necessary to finely adjust clock tree balance, thereby to reduce the clock signal skew to acceptable limits. However when differences in clock signal path delays to sinks 10 at the pre-insertion stage of the synthesis process depicted in FIG. 3 are large, the CTS tool may have difficulty compensating for those differences by buffer insertions. In such case a conventional CTS tool may restart the clock tree synthesis process anew, altering the way in which it initially allocates sinks 10 to clusters 18 in the hopes that doing so will produce a better result. In some cases a CTS tool may have to try several initial clusterization plans before finding one that leads to a clock tree design that can be adequately balanced by buffer insertions.

Gated Clock Trees

To aid IC testing or for other reasons, clock trees in some ICs include logic gates at various points acting as switches allowing control signals to selectively prevent the clock signal from reaching selected groups of sinks. For example, FIG. 6 illustrates an unbalanced clock tree 30 for the sink placement illustrated in FIG. 1 that is topologically similar to clock tree 25 of FIG. 3 except that clock tree 30 includes gates 27 and 28 in selected branches. The IC designer specified that gate 27 is to gate a particular set of sinks 10A-10C and that gate 28 is to gate another set of particular six sinks 10D as well as gate 27. Thus gated clock tree 30 is “hierarchical” in that one gate may reside downstream of another.

The designer's gating specification imposes restrictions on how a CTS tool employing a zero skew algorithm may initially organize the sinks into clusters. FIG. 7 illustrates how a conventional zero skew algorithm might assign the sinks of FIG. 6 to clusters as necessary to preserve the specified gating hierarchy. Even though sinks 10A-10C are widely separated in the IC layout, the zero skew algorithm groups them into the same cluster 31 because they are all to be gated by the same gate 27. All other sinks 10 must be excluded from cluster 31. Similarly the algorithm must group sinks 10D into clusters 32 and 33 excluding all other sinks 10 that are not to be gated by gate 28. By comparing FIGS. 2 and 7 we can see that the constraints on clustering imposed by gates 27 and 28 can have the effect of increasing variations in distances between sinks assigned to the same cluster.

During a next iterative step after clusterizing the sinks as illustrated in FIG. 7, the zero skew algorithm must assign the first level buffers 20 that are to drive the sinks of clusters 31, 32 and 33 into the same higher level cluster, even though they may be widely separated, because they must receive the clock signal via gate 28. Thus the zero skew algorithm is not free to cluster first level buffers 20 in a way that minimizes distances between buffers assigned to the same cluster.

Accordingly when the design of gate clock tree 30 reaches the pre-balancing stage depicted in FIG. 6, and the CTS tool is ready to insert additional buffers to compensate for differences in path distances, the CTS tool will find that initial skew of the gated clock tree 30 of FIG. 6 is much larger than the initial skew of the ungated clock tree 25 of FIG. 3. The CTS tool will therefore be more likely to fail in its attempt to develop a buffer insertion plan for gated clock tree 30 that will reduce clock skew to acceptable levels.

What is needed is a CTS tool that can synthesize a balanced, gated clock tree even though downstream sinks and gates to be gated by the same gate are widely separated in the IC layout.

### BRIEF SUMMARY OF THE INVENTION

The invention relates to a method a CTS tool may employ for synthesizing a gated clock tree for an IC, wherein the gated clock tree incudes gates and buffers interconnected by signal paths for conveying a clock signal downstream from a root node to a plurality of sinks within the IC.

In accordance with the method of the present invention, the CTS tool selects each gate to be included in the clock tree in turn, in hierarchical order, starting with gates at the lowest levels of the gate hierarchy and working upstream. Upon selecting any gate, the CTS tool designs a subtree of gated clock tree residing downstream of the selected gate, with the design for that subtree incorporating the design of any previously designed subtree residing downstream of any gates that are downstream of the selected gate. After all subtrees of the clock tree residing downstream of gates have been synthesized, the CTS tool designs all portions of the clock tree residing upstream of all gates.

Before synthesizing a subtree downstream of a selected gate, the CTS tool determines whether a conventional zero skew algorithm can be used to synthesize that subtree based on an analysis of the distribution of sinks and gates that are to reside downstream of the selected gate. A conventional zero skew algorithm performs poorly when the total number of subtrees to be connected by the clock tree is large and the path delays from the root node of the subtree to the sinks served by it vary substantially In such case the CTS tool first determines a position of a centroid of a set of all sinks and gates residing downstream of the selected gate that are to receive the clock signal via the selected gate without first passing through any other gate downstream of the selected gate. The CTS tool then establishes a set of subtree endpoints, each residing between the centroid and a corresponding downstream sink or gate. The CTS tool then employs a conventional zero-skew algorithm to synthesize a balanced subtree for conveying the clock signal from the selected gate to each subtree endpoint. The CTS tool also synthesizes a set of signal paths for conveying the clock signal from each subtree endpoint to a corresponding one of the downstream sinks and gates, with buffers sized and positioned within those signal paths to limit differences in path delays between the selected gate and all sinks of the clock tree residing downstream of selected gate.

The claims appended to this specification particularly point out and distinctly claim the subject matter of the invention. However those skilled in the art will best understand both the organization and method of operation of what the applicant(s) consider to be the best mode(s) of practicing the invention, together with further advantages and objects of the invention, by reading the remaining portions of the specification in view of the accompanying drawing(s) wherein like reference characters refer to like elements.

### BRIEF DESCRIPTION OF THE DRAWINGS

FIG. 1 is a simplified plan view of a prior art IC layout illustrating positions of a set of sinks;

FIG. 2 is a simplified plan view of the prior art IC layout of FIG. 1 illustrating how a prior art zero-skew algorithm assigns sinks to clusters and positions first level buffers for supping clock signals to the sinks of each cluster;

FIG. 3 illustrates in schematic diagram form a prior art unbalanced clock tree for distributing a clock signal to each sink of FIG. 1;

FIG. 4 is a simplified plan view of the prior art IC layout of FIG. 2 illustrating how the prior art zero-skew algorithm assigns the first level buffers of FIG. 2 to clusters and positions second level buffers for supplying clock signals to the first level buffers of each cluster;

FIG. 5 illustrates in schematic diagram form a balanced version of the clock tree of FIG. 3;

FIG. 6 illustrates in schematic diagram form an unbalanced prior art gated clock tree;

FIG. 7 is a simplified plan view of an IC layout illustrating positions of a set of sinks to receive a clock signal through a gated clock tree, and indicating how a prior art zero-skew algorithm assigns the sinks to clusters;

FIG. 8 illustrates in schematic diagram form a gated clock tree produced in accordance with the present invention;

FIGS. 9 and 10 are simplified plan views of an IC layout indicating portions of a gated clock tree synthesized in accordance with the invention;

FIG. 11 is a flow chart illustrating a method for synthesizing a gated clock tree in accordance with the invention;

FIG. 12 is a flow chart illustrating in more detail a step of the method illustrated in FIG. 11; and

FIGS. 13-16 are schematic diagram illustrations of subtrees of a gated clock tree synthesized in accordance with the invention.

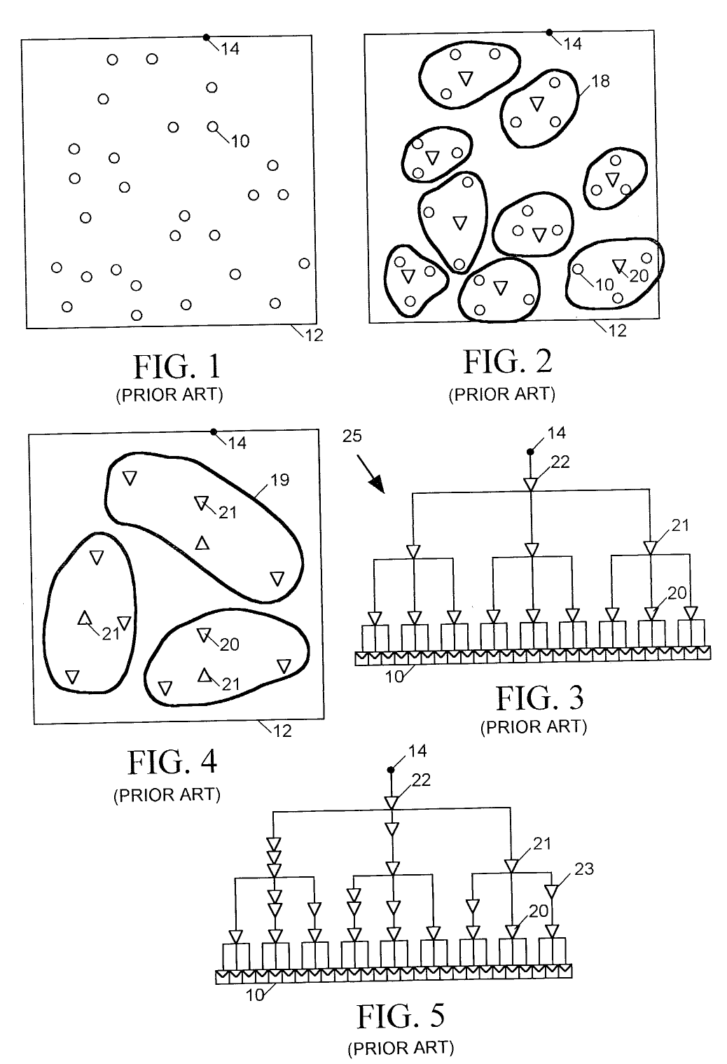

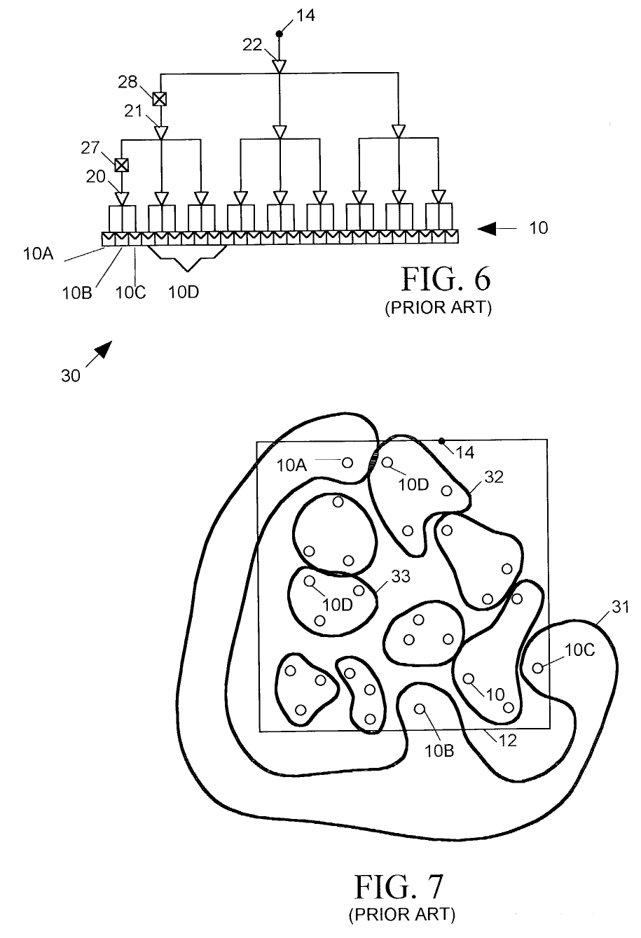

### DETAILED DESCRIPTION OF THE INVENTION

The present invention relates to software stored on computer readable media which, when read and executed by a conventional computer, causes the computer to act as a clock tree synthesis (CTS) tool for designing a gated clock tree for an integrated circuit (IC). Suitable computer-readable media for storing software include, but are not limited to, compact disks, floppy disks, hard disks, random access memory and read only memory. While the specification below describes an exemplary embodiment of the invention considered by the applicants to be best mode of practicing the invention, the claims appended to this specification are intended to cover all modes of practicing the invention.

Integrated circuits (ICs) often include clocked devices (“sinks”) such as registers, latches and flip-flops that carry out logic or data storage operations only in response to edges of an input clock signal. A “clock tree”is a tree-like network formed by conductors and buffers for distributing a clock signal to all of the sinks within an IC that are clocked by that clocked signal. To make sure that state changes in all sink output signals occur synchronously, a CTS tool that designs a clock tree balances it by adjusting delays in selected branches of the clock tree so that clock signal edges arrive at all of the sinks with relatively little time difference (“skew”).

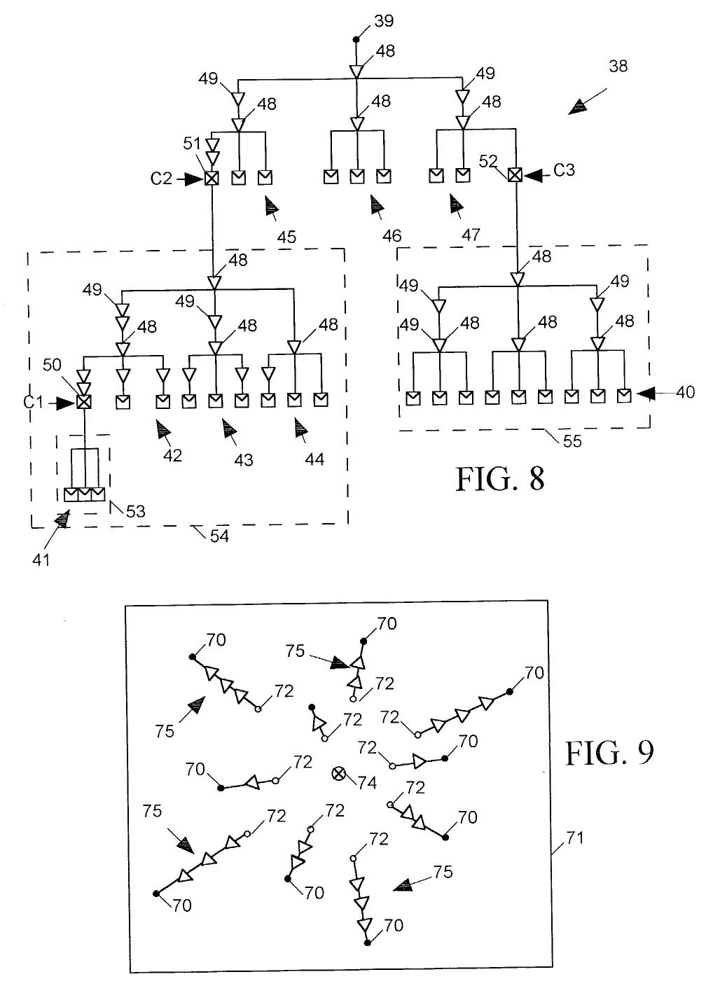

The present invention relates in particular to a CTS tool for designing a “gated clock tree” including one or more gates acting as switches to allow control signals to selectively prevent a clock signal from passing to downstream sinks. FIG. 8 schematically illustrates a simple example of a gated clock tree 38 as might be designed by a CTS tool in accordance with the invention, for delivering a clock signal from its root node 39 to a set of sinks 40-47 via a network of buffers 48 that fan out the clock signal out as it travels to the sinks. The CTS tool also inserts some additional buffers 49 into various branches of the clock tree to alter path delays within those branch as needed to limit clock signal skew.

Clock tree 38 also includes a gate 50 controlled by a control signal C1 for selectively allowing the clock signal to pass to a subtree 53 immediately downstream of the gate. Similarly, gates 51 and 52 controlled control signals C2 and C3 selectively allow the clock signal to pass to downstream subtrees 54 and 55, respectively. Notice that gates 50-52 form a hierarchy of gates. Gates 50 and 52 reside at the lowest level of the gate hierarchy because no other gates reside downstream of gates 50 and 52. Gate 51 resides at a higher level of the gate hierarchy because at least one first level gate (gate 50) resides downstream. Although in the simple example of FIG. 8, clock tree 38 includes only three gates residing on two hierarchical levels, a large IC may include a large clock tree having many more gates at many more hierarchical levels.

A CTS tool in accordance with the invention synthesizes a clock tree by synthesizing the subtree under each gate starting with gates residing at the lowest level of the gate hierarchy and working upward through the hierarchy. The CTS tool then synthesizes the remaining portions of that clock tree that are not downstream of any gates. For the example clock tree 38 of FIG. 8, the CTS tool might initially synthesize the subtree 55 residing under first level gate 52, then synthesizes the subtree 53 residing under first level gate 50, and then synthesizes the subtree 54 residing under second level gate 51. Since subtree 53 forms a part of subtree 54, the CTS tool incorporates the design of subtree 53 into subtree 54. After synthesizing the subtrees under all gates, the CTS tool synthesizes the entire clock tree, incorporating all previously synthesized subtrees into the design. For example after synthesizing subtrees 53-55 of FIG. 8, the CTS tool would synthesize the portions of clock tree 38 that do not reside downstream of gates 50-52.

Zero-Skew Algorithm

A CTS tool in accordance with the invention may employ a conventional zero-skew algorithm to design each subtree. As discussed above, a conventional zero-skew algorithm assigns each sink of a subtree by initially assigning the sinks to be served by the subtree to a set of clusters, where each cluster is to be driven by the same first level buffer. The zero-skew algorithm assigns nearest neighbor sinks to the same cluster so that when it positions each first level fan-out buffer near its corresponding cluster, the path distance from the first level fan-out buffer to each sink of the cluster will be as uniform as possible. The zero-skew algorithm then organizes nearby first level fan-out buffers into clusters to be driven by nearby second level fan-out buffers. The process continues until a sufficient number of buffer levels are provided to fan the clock signal out from the root node of the subtree to each sink. The zero-skew algorithm then inserts additional buffers into selected branches of the subtree, sizing and positioning the inserted buffers as necessary to reduce clock skew to acceptable limits. In the example of FIG. 8, subtree 55 includes three clusters 56 of gates 40, four fan-out buffers 48 and three buffers 49 inserted in various branches of the subtree to minimize skew.

Subtree Balancing

As shown in FIG. 7, while ungated sinks assigned to the same clusters 32 and 33 are usually close to one another, gated sinks 10A-10C assigned to the same cluster 31 can be widely distributed. Since the gates of cluster 31 are more widely distributed than gates of other clusters, such as clusters 32 and 33, the path delay from first level fan-out buffer to sink can vary greatly from cluster-to-cluster. In such case a conventional zero-skew algorithm may not be able to design an adequately balanced a subtree for delivering the clock signal to all sinks. Accordingly, upon clusterizing endpoints 70 in a way that takes into account the clock tree's specified gating scheme, a CTS tool in accordance with the invention determines whether the resulting path delays from the root of the subtree to the sinks would vary substantially, and if so, carries out a subtree balancing process before using a conventional zero-skew algorithm to synthesize the subtree.

For example, FIG. 9 is a simplified plan view of an IC layout 71 showing a set of subtree “endpoints” 70, which are initially the clock signal input terminals of a set of sinks assigned to the same cluster to be served by the same gated subtree. When endpoints 70 are distributed and clusterized in a way that would not permit a conventional zero-skew algorithm to design a balanced subtree for delivering a clock signal to them from a common root node, the CTS tool first chooses a position for a reference point 74 within the layout in the vicinity of all subtree endpoints, suitably at the centroid of all endpoints 70. The CTS tool then selects positions for a new set of subtree endpoints 72, each located midway between centroid 74 and a separate one of old subtree endpoints 70. Thereafter the CTS tool designs a buffered signal path 75 between each new end point 72 and its corresponding old end point 70, with buffers being sized and positioned within each signal path 75 to substantially equalize the clock signal path delay from each new endpoint 72 to inputs of the sink linked to its corresponding old endpoint 70. Since the path delays from new end points 72 to the sinks of the subtrees rooted at old points 70 will not vary substantially, and since the distances separating new end points 72 are smaller than the distances separating old end points 70, a conventional zero-skew algorithm will be better able to synthesize a balanced subtree for delivering a clock signal to new endpoints 72 than to old endpoints 70.

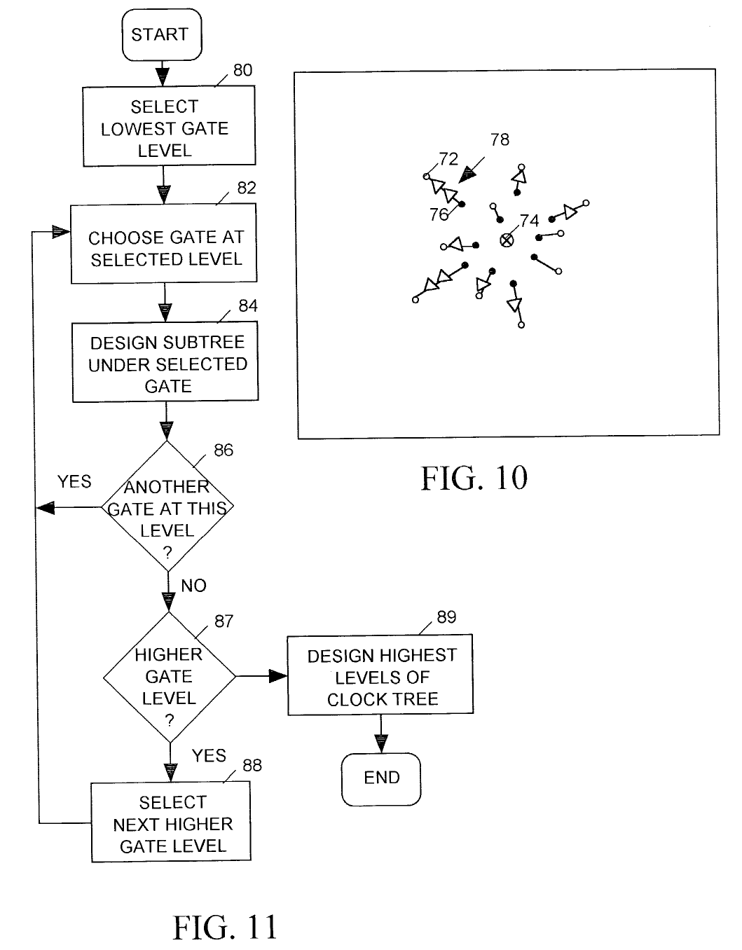

However, if after carrying out the balancing process, the CTS tool finds that the path delays to new subtree endpoints 72 are still too widely varying for a conventional zero-skew algorithm to successfully synthesize a balanced subtree for delivering a clock signal to them, then the CTS tool repeats the process as illustrated in FIG. 10, thereby producing a next set of subtree endpoints 76 midway between endpoints 72 and centroid 74. The CTS tool inserts buffers in the paths 78 between endpoints 72 and 76 as necessary to equalize the delays there between. The CTS tool can repeat this process as many times as necessary to make the differences in path delays from the new end point 76 to the sinks of the subtrees rooted at points 72 sufficiently small to render the zero-skew algorithm effective for designing balanced subtree for delivering a clock signal from a root node to all endpoints.

The CTS Algorithm

FIG. 11 illustrates an example embodiment of an algorithm a CTS tool in accordance with the invention may carry out when synthesizing a gated clock tree. CTS tool initially selects the lowest gate level (step 80), chooses a gate at the selected level (step 82), and then synthesizes the subtree residing under the selected gate (step 84). For clock tree 38 of FIG. 8, since gates 50 and 52 reside at the lowest level of the gate hierarchy, the CTS tool selects one of gates 50 and 52 at step 82. Assuming the CTS tool initially selects gate 52 at step 82, the CTS tool synthesizes the subtree 55 residing directly under the selected gate 52 at step 84.

When there is another gate at the selected level (step 86), the CTS tool chooses a next gate at that level (step 82) and synthesizes the subtree under that gate (step 84). In the example of FIG. 8, the CTS tool would next choose first level gate 50 and then synthesize the subtree 53 residing under gate 50.

The CTS tool continues to loop through steps 82-86 synthesizing the subtree under each first level gate, until it has synthesized the subtrees under all first level gates. When there is a next higher gate level (step 87), the CTS tool selects the next higher gate level (step 88), chooses one of the gates at the selected level (step 82) and then synthesizes the subtree under the selected gate (step 84). In the example of FIG. 8, after synthesizing subtrees 53 and 55 under first level gates 50 and 52, the CTS tool selects the second gate level at step 88, selects gate 51 at step 82 and then synthesizes the subtree 54 residing under that gate. Since at that point a portion (subtree 53) of subtree 54 will already have been synthesized, the CTS tool incorporates the design of subtree 53 into the design of subtree 54.

The CTS tool continues to loop through steps 82-88 synthesizing subtrees under progressively higher level gates, until at step 87 it determines that it has synthesized subtrees downstream of all gates. At that point, the CTS tool synthesizes the entire clock tree (step 89) including portions of the clock tree not downstream of any gate. In the example of FIG. 8, the CTS tool would synthesize the entire clock tree 38, with the design of clock tree 38 incorporating previously synthesized designs of subtrees 54 and 55.

Subtree Synthesis

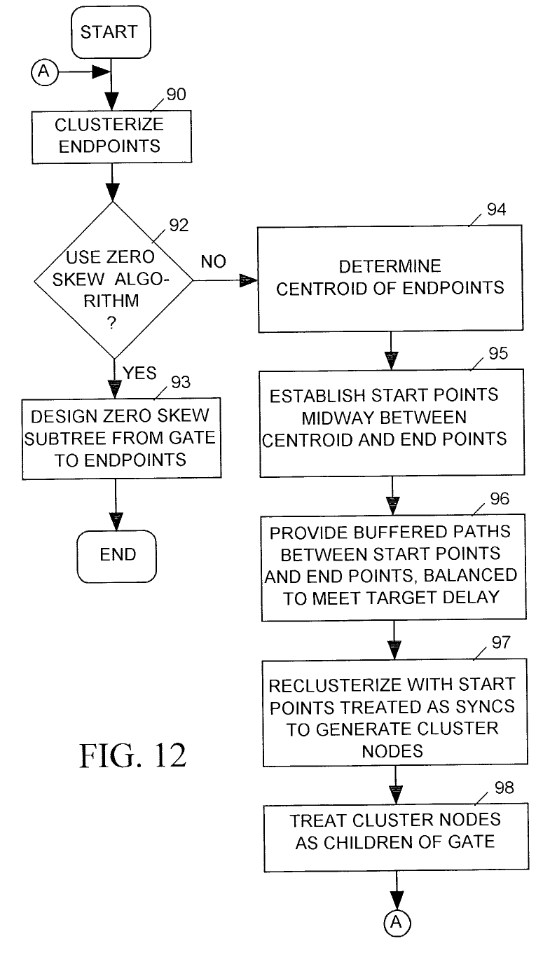

FIG. 12 illustrates the subtree synthesis step 84 of FIG. 11 in more detail. The CTS tool initially (step 90) clusterizes the subtrees endpoints, which are initially at the inputs of the selected gate's “immediate children” sinks and gates that are to receive the clock signal directly via the selected gate without passing through any other lower level gates. For example in FIG. 8, the immediate children of gate 50 are sinks 41, the immediate children of second level gate 51 are sinks 42-44 and first level gate 50, and the immediate children of gate 52 are sinks 40.

The CTS tool then analyzes the clusters created at step 90 to determine whether the conventional zero-skew algorithm will be able to successfully synthesize a balanced subtree (step 92). When the CTS tool determines that the zero-skew algorithm will be successful, it employs a conventional zero-skew algorithm at step 93 to synthesize a subtree for delivering the clock signal to the clock tree's endpoints.

Otherwise, when the CTS tool determines at step 92 that the zero-skew algorithm will not be successful, it employs a subtree compression process in accordance with the invention (steps 94-98) to compress the area containing the subtree's endpoints so that the zero-skew algorithm will more likely be successful. The CTS tool then returns to step 90 to again clusterize the gate's endpoints, and at this point, due to the subtree compression process carried out at step 94-98, the subtree endpoints will appear to be closer together. Since path delays from first-level fan-out buffers to endpoints within the clusters will be more nearly uniform, the zero-skew algorithm will more likely to be successful. However the CTS tool may repeat the subtree compression process (steps 94-98) more than once when necessary to render the subtree suitable for the zero-skew algorithm at step 93.

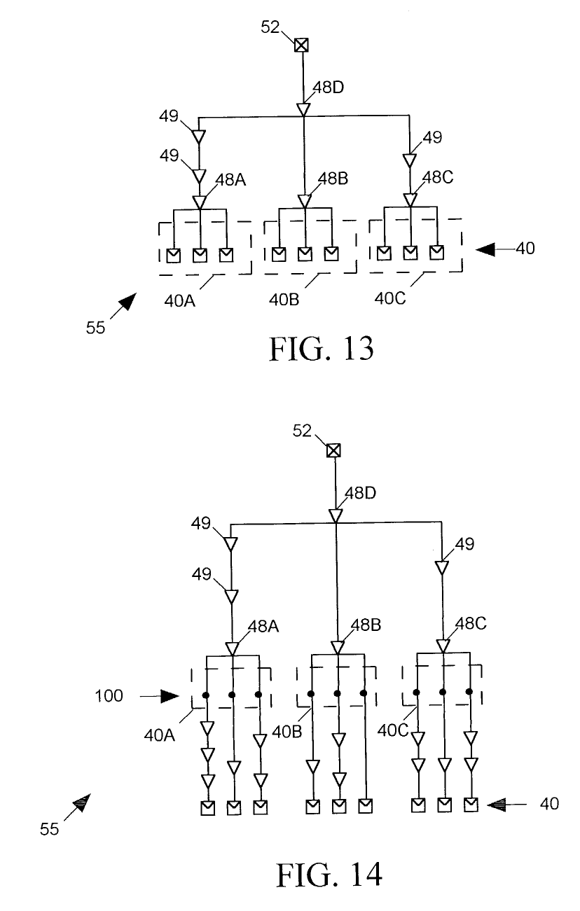

As mentioned above, the CTS tool (at step 92) analyzes the endpoint clusters created at 90 to determine whether it is necessary to employ the subtree compression algorithm (steps 94-98) before using the zero-skew algorithm. The determination is based on whether the expected clock signal path delay from the first-level buffers to all clock tree endpoints are relatively uniform. For example as illustrated in FIG. 13, when synthesizing subtree 55 of clock tree 38, CTS tool initially organizes the trees endpoints (sinks 40) into a set of three clusters 40A-40C and determines whether the expected path delay from each first level buffer 48A-48C to each sink 40 its serves is sufficient uniform, assuming that buffers 48A-48C are to be positioned at a centroids of the gates 40 included in their corresponding clusters 40A-40C. If the variation in path delay is not too large the zero skew algorithm is employed to synthesize subtree 55 from the output of gate 52 to the subtree endpoints at the input of each gate 40. As illustrated in FIG. 13, the subtree includes fan-out buffers 48A-48D and some additional buffers 49 inserted in various branches to balance the subtree.

Conversely, when the path delays within clusters 40A-40C are not sufficiently similar, the CTS tool employs the subtree compression process as illustrated in FIG. 14. Here a new set of clock tree endpoints 100 are established that are midway between gates 40 and the centroid of those gates. Buffers 102 are inserted in paths between new endpoints 100 and gates 40 as necessary to equalize the path delays between each endpoint 100 and its corresponding gate 40 input. The CTS then organizes endpoints 100 into the set of clusters 40A-40C and determines whether the path delays from fan-out buffers 48A-48C positioned at the centroids of their respective clusters would be sufficiently uniform. If so, the CTS tool employs the zero-skew algorithm to design the portion of the tree extending from 52 to endpoints 100.

Macros

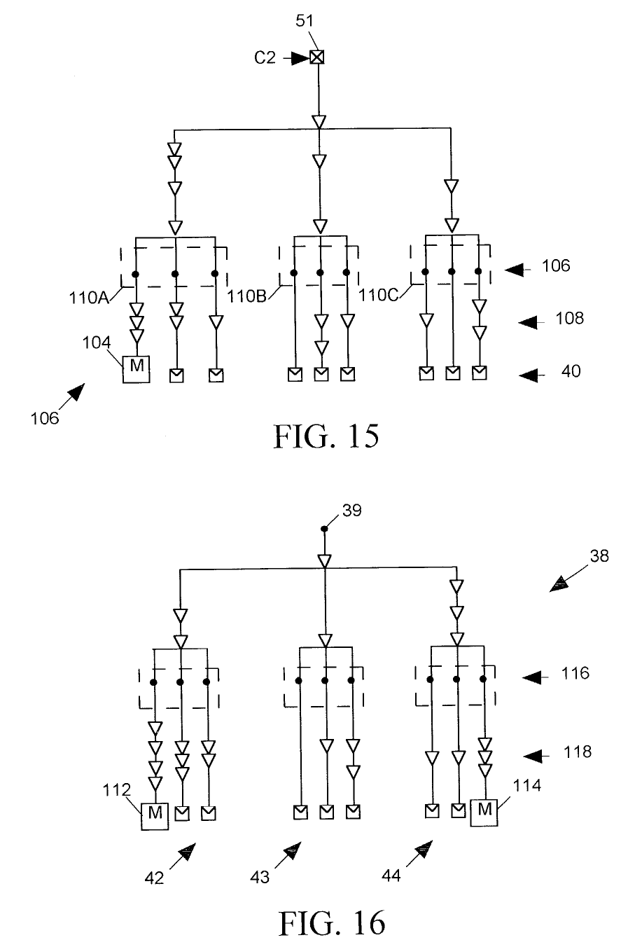

When synthesizing a higher level subtree incorporating a previously synthesized lower level subtree, the CTS tool represents the lower level subtree and its gate as a “macro” positioned at the input of the lower level gate at the root of the lower level subtree. For example, as illustrated in FIG. 15, when synthesizing subtree 54 of FIG. 8, the downstream subtree 53 under gate 50 will have already been synthesized, and the CTS tool will replace them with a macro 104 positioned at the input of gate 50. The macro represents the average path delay from the input of gate 50 to the input of each sink downstream of gate 50.

Thereafter macro 104 is treated as an endpoint during the clusterization process at step 90 of FIG. 13. When analyzing the clusters at step 92, the CTS tool takes into account the path delay represented by macro 104 when determining whether to employ subtree compression. In the example illustrated in FIG. 15, the CTS tool determined that the path delay differences were large and therefor carried out a subtree compression process. In doing so the CTS tool established a new set of endpoints 106 and added buffers 108 as necessary to substantially equalize the path delays between endpoints 106 and macro 104 and sinks 42-45. The CTS tool thereafter organized endpoints 106 into clusters 110A-110C and then determined by analyzing variations in path delays associated with clusters 106 that it could employ the zero skew algorithm to synthesize the remaining portion of subtree 54 upstream of endpoints 106.

The process the CTS tool uses at step 89 of FIG. 11 to design the higher levels of the clock tree that are not downstream of any gate is similar to the process it uses at step 84 (FIG. 12) to design each subtree. At that stage the “endpoints” of the tree are the children of the clock tree's root node, including all ungated sinks and macros representing previously synthesized subtrees. For example, as illustrated in FIG. 16, the CTS tool represents gate 51 and subtree 54 as a macro 112 positioned at the input of gate 51, and treats gate 52 and its subtree 55 as a macro 114 positioned at the input of gate 52. The path delay associated with macro 112 is the average path delay gate 51 from the input of gate 51 to each sink 41-44 residing under that gate, while the path delay associated with macro 114 is the average path delay from the input of gate 52 to sinks 40. In the example illustrated in FIG. 16, the CTS tool has employed one or more subtree compression cycles to establish a set of endpoints 116 linked to macros 112 and 114 and gates 42-44 though buffers 118 sized and positioned to substantially equalize path delays from endpoints 116 to macros 112 and 114 and gates 42-44. The CTS tool then employs the conventional zero-skew algorithm to synthesize the portions of clock tree 38 upstream of endpoints 116

Thus has been described a method for synthesizing a gated clock tree of an IC, wherein the gated clock tree incudes gates and buffers interconnected by signal paths for conveying a clock signal from a root node downstream through the clock tree to a plurality of sinks within the IC. The method as described includes selecting each gate to be included in the clock tree in hierarchical order, synthesizing a portion of gated clock tree residing downstream of each selected gate, and then synthesizing portions of the clock tree residing upstream of all gates to be included in the clock tree. When synthesizing the portion of the clock tree residing under any selected gate, the CTS tool first determines a position of a centroid of a set of any and all sinks and gates residing downstream of the selected gate that are to receive the clock signal via the selected gate without first passing through any other gate downstream of the selected gate. The CTS tool then establishes a set of subtree endpoints, each residing between the centroid and a corresponding sink or gate of the downstream set of sinks and gates. Thereafter the CTS tool synthesizes a separate signal path for conveying the clock signal from each subtree endpoint to each one of the sinks and gates of the set, and synthesizes a balanced subtree for conveying the clock signal from the selected gate to each subtree endpoint. Buffers are included in the signal paths between the subtree endpoints and the corresponding sinks and gates, the buffers being sized and positioned to limit differences in path delays between the selected gate and all sinks of the clock tree residing downstream of selected gate.

The foregoing specification and the drawings depict an exemplary embodiment of the best mode of practicing the invention, and elements or steps of the depicted best mode exemplify the elements or steps of the invention as recited in the appended claims. However the appended claims are intended to apply to any mode of practicing the invention comprising the combination of elements or steps as described in any one of the claims, including elements or steps that are functional equivalents of the example elements or steps of the exemplary embodiment of the invention depicted in the specification and drawings.

1. A method for modifying a design of an integrated circuit (IC) specifying a layout of a plurality of sinks so that the design also specifies a layout of a clock tree that is to deliver a clock signal from a root node within the IC to each of the sinks, the method comprising the steps of:
a. identifying positions within the IC of a first subset of the sinks;
b. selecting a first point within the IC;
c. selecting positions within the IC of a plurality of first subtree endpoints, wherein each first subtree endpoint corresponds to a separate sink of the first subset and resides substantially between and spaced from its corresponding sink and the first point; and
d. modifying the design so that it specifies layouts of a plurality of first signal paths, wherein each first signal path extends between a separate one of the first subtree endpoints and its corresponding sink.

2. The method in accordance with claim 1 further comprising the steps of:
e. determining a position of a first gate within the IC; and
f. modifying the design to specify a layout of a first subtree of the clock tree for delivering the clock signal from the first gate to the first subtree endpoints.

3. The method in accordance with claim 2 wherein the first subtree includes buffers sized and positioned such that the first subtree delivers the clock signal from the first gate to each first subtree endpoint with substantially similar path delays.

4. The method in accordance with claim 1 wherein the first point is proximate to a centroid of the identified positions of the first subset of sinks.

5. The method in accordance with claim 1 wherein each first subtree endpoint resides substantially midway between its corresponding sink and the first point.

6. The method in accordance with claim 1 wherein the first signal paths as specified provide substantially similar path delays.

7. The method in accordance with claim 5 wherein at least one of the first signal paths as specified includes a buffer for buffering the clock signal.

8. The method in accordance with claim 7 wherein the first subtree includes buffers sized and positioned such that the first subtree delivers the clock signal from the first gate to each first subtree endpoint with substantially similar path delays.

9. The method in accordance with claim 3
wherein the first point is proximate to a centroid of the identified positions of the first subset of sinks,
wherein each first subtree endpoint resides substantially midway between its corresponding sink and the first point,
wherein the first signal paths as specified provide substantially similar path delays,
wherein at least one of the first signal paths as specified includes a buffer for buffering the clock signal, and
wherein the first subtree includes buffers sized and positioned such that the first subtree delivers the clock signal from the first gate to each first subtree endpoint with substantially similar path delays.

10. The method in accordance with claim 2 further comprising the steps of:
g. identifying positions within the IC of a second subset of the sinks;
h. selecting a second point within the IC;
i. selecting positions within the IC of a plurality of second subtree endpoints, wherein a first one of the second subtree endpoints resides substantially between and spaced from its the first gate the second point, and wherein each other second subtree endpoint corresponds to a separate sink of the second subset and resides substantially between and spaced from its corresponding sink and the second point; and
j. modifying the design so that it specifies layouts of a plurality of second signal paths, wherein one of the second signal paths extends from the first one of the second subtree endpoints to the first gate, and wherein each other of the second signal paths extends between a separate one of the other second subtree endpoints and its corresponding sink.

11. The method in accordance with claim 10 further comprising the steps of:
k. determining a position of a second gate within the IC; and
l. modifying the design to specify a layout of a second subtree of the clock tree for delivering the clock signal from the second gate to the second subtree endpoints.

12. The method in accordance with claim 11 wherein second subtree includes buffers sized and positioned such that the second subtree delivers the clock signal from the second gate to each second subtree endpoint with substantially similar path delays.

13. The method in accordance with claim 10 wherein the second point is proximate to a centroid of the identified positions of the second subset of sinks and the first gate.

14. The method in accordance with claim 10 wherein the first one of the second subtree endpoints resides substantially midway between the first gate and the second point and wherein each other second subtree endpoint resides substantially midway between its corresponding sink and the second point.

15. The method in accordance with claim 10 wherein all second signal paths as specified provide substantially similar path delays.

16. The method in accordance with claim 14 wherein at least one of the second signal paths as specified includes a buffer for buffering the clock signal.

17. The method in accordance with claim 16 wherein second subtree includes buffers sized and positioned such that the second subtree delivers the clock signal from the second gate to each second subtree endpoint with substantially similar path delays.

18. The method in accordance with claim 12
wherein the first subtree includes buffers sized and positioned such that the first subtree delivers the clock signal from the first gate to each first subtree endpoint with substantially similar path delays,
wherein the first point is proximate to a centroid of the identified positions of the first subset of sinks,
wherein each first subtree endpoint resides substantially midway between its corresponding sink and the first point,
wherein the first signal paths as specified provide substantially similar path delays,
wherein at least one of the first signal paths as specified includes a buffer for buffering the clock signal, and
wherein the first subtree includes buffers sized and positioned such that the first subtree delivers the clock signal from the first gate to each first subtree endpoint with substantially similar path delays,
wherein the second point is proximate to a centroid of the identified positions of the second subset of sinks and the first gate,
wherein the first one of the second subtree endpoints resides substantially midway between the first gate and the second point and wherein each other second subtree endpoint resides substantially midway between its corresponding sink and the second point,
wherein all second signal paths as specified provide substantially similar path delays,
wherein at least one of the second signal paths as specified includes a buffer for buffering the clock signal, and
wherein second subtree includes buffers sized and positioned such that the second subtree delivers the clock signal from the second gate to each second subtree endpoint with substantially similar path delays.

19. Computer readable media storing software which when read and executed by a computer causes the computer to carry out a method for modifying a design of an integrated circuit (IC) specifying a layout of a plurality of sinks so that the design also specifies a layout of a clock tree that is to deliver a clock signal from a root node within the IC to each of the sinks, wherein the method comprises the steps of:
a. identifying positions within the IC of a first subset of the sinks;
b. selecting a first point within the IC;
c. selecting positions within the IC of a plurality of first subtree endpoints, wherein each first subtree endpoint corresponds to a separate sink of the first subset and resides substantially between and spaced from its corresponding sink and the first point; and
d. modifying the design so that it specifies layouts of a plurality of first signal paths, wherein each first signal path extends between a separate one of the first subtree endpoints and its corresponding sink.

20. The computer readable media in accordance with claim 19 wherein the method further comprises the steps of:
e. determining a position of a first gate within the IC; and
f. modifying the design to specify a layout of a first subtree of the clock tree for delivering the clock signal from the first gate to the first subtree endpoints.

21. The computer readable media in accordance with claim 20 wherein the first subtree includes buffers sized and positioned such that the first subtree delivers the clock signal from the first gate to each first subtree endpoint with substantially similar path delays.

22. The computer readable media in accordance with claim 19 wherein the first point is proximate to a centroid of the identified positions of the first subset of sinks.

23. The computer readable media in accordance with claim 19 wherein each first subtree endpoint resides substantially midway between its corresponding sink and the first point.

24. The computer readable media in accordance with claim 19 wherein the first signal paths as specified provide substantially similar path delays.

25. The computer readable media in accordance with claim 24 wherein at least one of the first signal paths as specified includes a buffer for buffering the clock signal.

26. The computer readable media in accordance with claim 25 wherein the first subtree includes buffers sized and positioned such that the first subtree delivers the clock signal from the first gate to each first subtree endpoint with substantially similar path delays.

27. The computer readable media in accordance with claim 21
wherein the first point is proximate to a centroid of the identified positions of the first subset of sinks,
wherein each first subtree endpoint resides substantially midway between its corresponding sink and the first point,
wherein the first signal paths as specified provide substantially similar path delays,
wherein at least one of the first signal paths as specified includes a buffer for buffering the clock signal, and
wherein the first subtree includes buffers sized and positioned such that the first subtree delivers the clock signal from the first gate to each first subtree endpoint with substantially similar path delays.

28. The computer readable media in accordance with claim 20 wherein the method further comprises the steps of:
g. identifying positions within the IC of a second subset of the sinks;
h. selecting a second point within the IC;
i. selecting positions within the IC of a plurality of second subtree endpoints, wherein a first one of the second subtree endpoints resides substantially between and spaced from its the first gate the second point, and wherein each other second subtree endpoint corresponds to a separate sink of the second subset and resides substantially between and spaced from its corresponding sink and the second point; and
j. modifying the design so that it specifies layouts of a plurality of second signal paths, wherein one of the second signal paths extends from the first one of the second subtree endpoints to the first gate, and wherein each other of the second signal paths extends between a separate one of the other second subtree endpoints and its corresponding sink.

29. The computer readable media in accordance with claim 28 wherein the method further comprises the steps of:
k. determining a position of a second gate within the IC; and
l. modifying the design to specify a layout of a second subtree of the clock tree for delivering the clock signal from the second gate to the second subtree endpoints.

30. The computer readable media in accordance with claim 29 wherein second subtree includes buffers sized and positioned such that the second subtree delivers the clock signal from the second gate to each second subtree endpoint with substantially similar path delays.

31. The computer readable media in accordance with claim 28 wherein the second point is proximate to a centroid of the identified positions of the second subset of sinks and the first gate.

32. The computer readable media in accordance with claim 28 wherein the first one of the second subtree endpoints resides substantially midway between the first gate and the second point and wherein each other second subtree endpoint resides substantially midway between its corresponding sink and the second point.

33. The computer readable media in accordance with claim 28 wherein all second signal paths as specified provide substantially similar path delays.

34. The computer readable media in accordance with claim 22 wherein at least one of the second signal paths as specified includes a buffer for buffering the clock signal.

35. The computer readable media in accordance with claim 34 wherein second subtree includes buffers sized and positioned such that the second subtree delivers the clock signal from the second gate to each second subtree endpoint with substantially similar path delays.

36. The computer readable media in accordance with claim 30
wherein the first subtree includes buffers sized and positioned such that the first subtree delivers the clock signal from the first gate to each first subtree endpoint with substantially similar path delays,
wherein the first point is proximate to a centroid of the identified positions of the first subset of sinks,
wherein each first subtree endpoint resides substantially midway between its corresponding sink and the first point,
wherein the first signal paths as specified provide substantially similar path delays,
wherein at least one of the first signal paths as specified includes a buffer for buffering the clock signal, and
wherein the first subtree includes buffers sized and positioned such that the first subtree delivers the clock signal from the first gate to each first subtree endpoint with substantially similar path delays,
wherein the second point is proximate to a centroid of the identified positions of the second subset of sinks and the first gate,
wherein the first one of the second subtree endpoints resides substantially midway between the first gate and the second point and wherein each other second subtree endpoint resides substantially midway between its corresponding sink and the second point,
wherein all second signal paths as specified provide substantially similar path delays,
wherein at least one of the second signal paths as specified includes a buffer for buffering the clock signal, and
wherein second subtree includes buffers sized and positioned such that the second subtree delivers the clock signal from the second gate to each second subtree endpoint with substantially similar path delays.

37. A method for synthesizing a gated clock tree of an integrated circuit (IC), the gated clock tree comprising gates and buffers interconnected by signal paths for conveying a clock signal from a root node downstream through the clock tree to a plurality of sinks within the IC, the method comprising the steps of:
a. selecting a gate to be included in the clock tree;
b. synthesizing a portion of gated clock tree residing downstream of the selected gate;
c. repeating steps a and b with a separate one of the gates to be included in the clock tree being selected at each repetition of step a until each gate to be included in the clock tree has been selected at step a and a portion of the clock tree residing downstream of each gate to be included in the clock tree has been synthesized at step b; and
d. synthesizing portions of the clock tree residing upstream of all gates to be included in the clock tree.

38. The method in accordance with claim 37 wherein step b comprises the substeps of:
b1. determining a position of a centroid of a set of any and all sinks and gates residing downstream of the selected gate that are to receive the clock signal via the selected gate without first passing through any other gate downstream of the selected gate;
b2. establishing a set of subtree endpoints, each residing between the centroid and a corresponding sink or gate of the set of sinks and gates determined at substep b1;
b3. synthesizing a separate signal path for conveying the clock signal from each subtree endpoint to each one of the sinks and gates of the set; and
b4. synthesizing a balanced subtree for conveying the clock signal from the selected gate to each subtree endpoint.

39. The method in accordance with claim 39 wherein path delays within the signal paths synthesized at step b3 are selected to limit differences in path delays between the selected gate and all sinks of the clock tree residing downstream of selected gate.

40. The method in accordance with claim 39 wherein buffers are included in signal paths synthesized at step b3, sized and positioned to limit differences in path delays between the selected gate and all sinks of the clock tree residing downstream of selected gate.
